(19) United States
(12) Patent Application Publication
(10) Pub. No.: US 2025/0155742 A1
(43) Pub. Date: May 15, 2025

(54) DISPLAY PANEL AND DISPLAY TERMINAL

(71) Applicant: TCL CHINA STAR OPTOELECTRONICS TECHNOLOGY CO., LTD., Shenzhen (CN)

(72) Inventors: Dazhao WU, Shenzhen (CN); Weiwei XIAO, Shenzhen (CN); Junfang LV, Shenzhen (CN); Li CAI, Shenzhen (CN); Junjie LI, Shenzhen (CN)

(73) Assignee: TCL CHINA STAR OPTOELECTRONICS TECHNOLOGY CO., LTD., Shenzhen (CN)

(21) Appl. No.: 18/942,695

(22) Filed: Nov. 9, 2024

(30) Foreign Application Priority Data
Nov. 10, 2023 (CN) 202311502512.3

(51) Int. Cl. G02F 1/13; G02F 1/1333; G02F 1/1335; G02F 1/13363; G02F 1/1339

(52) U.S. Cl. CPC G02F 1/1323; G02F 1/133308; G02F 1/133528; G02F 1/13363; G02F 1/13394

(57) ABSTRACT

A display panel and a display terminal are provided. The display panel includes a first substrate, a second substrate, a liquid crystal layer, and an optical adjustment layer. The second substrate is spaced apart from and opposite to the first substrate, and a plurality of protrusions are provided on the surface of the second substrate away from the first substrate. The liquid crystal layer is between the first substrate and the second substrate. The optical adjustment layer is provided on the side of the second substrate away from the first substrate, the optical adjustment layer is provided with a plurality of grooves, and the grooves are fitted with corresponding protrusions. A refractive index of the second substrate is smaller than a refractive index of the optical adjustment layer.

### CROSS-REFERENCE TO RELATED APPLICATION

The application claims priority to and the benefit of Chinese Patent Application No. 202311502512.3, filed on Nov. 10, 2023, the disclosure of which is incorporated herein by reference in its entirety.

### TECHNICAL FIELD

The present application relates to the field of display technologies, and in particular, to a display panel and a display terminal.

### BACKGROUND

The viewing angle refers to the angle at which the display panel can be clearly observed from all directions. Due to the light source of the LCD panel having a certain directionality after being refracted and reflected, the LCD panel will have a picture distortion problem after exceeding a certain viewing angle, which limits the application of LCD panels in scenarios required with ultra-wide viewing angle (such as conference systems, public displays, etc.).

Therefore, there is a need to increase the viewing angle of LCD panels.

### SUMMARY

The application provides a display panel and a display terminal to increase the viewing angle of the display panel.

In order to solve the above-mentioned technical problems, a technical solution provided by the application is as follows:

The application provides a display panel, which includes:
a first substrate;
a second substrate spaced apart from and opposite to the first substrate, where a plurality of protrusions are disposed on a side surface of the second substrate away from the first substrate;
a liquid crystal layer disposed between the first substrate and the second substrate; and
an optical adjustment layer disposed on a side of the second substrate away from the first substrate, where the optical adjustment layer is provided with a plurality of grooves, and the grooves are fitted with corresponding protrusions;
wherein, a refractive index of the second substrate is less than a refractive index of the optical adjustment layer.

The present application further provides a display terminal. The display terminal includes a display panel, which includes:
a first substrate;
a second substrate spaced apart from and opposite to the first substrate, wherein a plurality of protrusions disposed on a side surface of the second substrate away from the first substrate;
a liquid crystal layer disposed between the first substrate and the second substrate; and
an optical adjustment layer disposed on a side of the second substrate away from the first substrate, wherein the optical adjustment layer is provided with a plurality of grooves, and the grooves are fitted with the corresponding protrusions;
wherein, a refractive index of the second substrate is less than a refractive index of the optical adjustment layer.

### BRIEF DESCRIPTION OF THE DRAWINGS

The technical solutions and other beneficial effects of the application will be apparent by a detailed description of the specific embodiments of the present application in conjunction with the accompanying drawings.

FIG. 1 is an exploded view of a display panel provided in an embodiment of the present application;

FIG. 2 is a schematic cross-sectional view illustrating a partial structure of the display panel shown in FIG. 1;

FIG. 3 is a schematic diagram illustrating a top view for the first structure of the display panel shown in FIG. 1;

FIG. 4 is a schematic diagram illustrating a top view for the second structure of the display panel in FIG. 1;

FIG. 5 is a schematic diagram illustrating a top view for the third structure of the display panel shown in FIG. 1;

### LIST OF THE REFERENCE SIGNS

Display area AA, non-display area NA, sub-pixel 1, first direction D1, second direction D2, first substrate 11, second substrate 12, protrusion 121, first sub-section 1211, second sub-section 1212, liquid crystal layer 13, optical adjustment layer 14, groove 141, first compensation layer 21, second compensation layer 22, first polarizing layer 31, second polarizing layer 32, first protective layer 41, second protective layer 42, adhesion layer 15, the angle A between the extending direction of the protrusion and the first direction, the length d1 of the top edge of the trapezoid, the height hl of the trapezoid, the base angle a of the trapezoid, and the distance d2 between two adjacent trapezoids.

### DETAILED DESCRIPTION

The technical solutions in the embodiments of the present application will be clearly and completely described according to the accompanying drawings in the embodiments of the present application. The described embodiments are only some of the embodiments of the present application, rather than all the embodiments. Based on the embodiments in the application, all other embodiments obtained by those skilled in the field without making creative efforts fall within the scope of protection of the application. In addition, it should be understood that the specific embodiments described here are only used to illustrate and explain the application, and are not used to limit the application. In the application, unless otherwise specified, the directional words used such as “upper” and “lower” usually refer to the upper and lower position of the device in actual use or working state, specifically to the direction of the drawing in the drawings, while “inside” and “outside” are understood referring to the contour lines of the device.

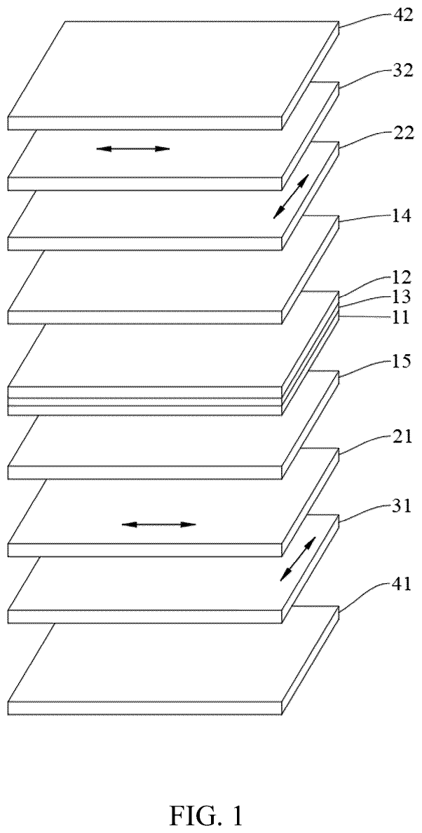

As shown in FIGS. 1-5, a display panel is provided, which includes a first substrate 11, a second substrate 12, a liquid crystal layer 13, and an optical adjustment layer 14, where the second substrate 12 is spaced apart from and opposite to the first substrate 11, and a plurality of protrusions 121 are disposed on a side surface of the second substrate 12 away from the first substrate 11. The liquid crystal layer 13 is disposed between the first substrate 11 and the second substrate 12. The optical adjustment layer 14 is disposed on the second substrate 12 on the side away from the first substrate 11. The optical adjustment layer 14 is provided with a plurality of grooves 141, and the grooves 141 are fitted with a corresponding one of the protrusions 121. In this embodiment, a refractive index of the second substrate 12 is less than a refractive index of the optical adjustment layer 14.

In the application, the protrusions 121 are disposed on the second substrate, and the grooves 141 fitted with the protrusions 121 are disposed on the optical adjustment layer 14. Additionally, the refractive index of the second substrate 12 is less than the refractive index of the optical adjustment layer 14, so that light is refracted at the interface between the protrusions 121 and the grooves 141 with a refraction angle less than the incident angle. As a result, the angle between the refracted light and the normal line of the plane of the second substrate 12 is increased, thereby increasing the viewing angle.

In this embodiment, the display panel is a liquid crystal display panel, and the liquid crystal display panel can be any of vertical alignment (VA) type, twisted nematic (TN), or super twisted nematic (STN) type, In-Plane Switching (IPS) type and Fringe Field Switching (FFS) type.

In the application, the display panel includes a display area AA and a non-display area NA located at the periphery of the display area AA, and the display area AA is used for displaying images. A plurality of sub-pixels 1 are disposed in the display area, and each sub-pixel 1 can display one kind of color. The display panel has a horizontal viewing angle and a vertical viewing angle. The horizontal viewing angle is the viewing angle in the horizontal direction, and the vertical viewing angle is the viewing angle in the vertical direction.

In this embodiment, the first substrate 11 is made of the same material as the second substrate 12 or different materials. The first substrate 11 and the second substrate 12 are made of transparent materials, such as glass, but are not limited thereto. The side of the second substrate 12 facing away from the first substrate 11 is the light emitting direction of the display panel, that is, the side of the second substrate 12 facing away from the first substrate 11 is used for displaying images.

The first substrate 11 could be an array substrate, and the second substrate 12 could be a color film substrate, but are not limited thereto. When the first substrate 11 is an array substrate, a driving circuit is also disposed on the first substrate 11, where the driving circuit is used to provide a driving voltage so as to control the deflection of liquid crystal molecules in the liquid crystal layer 13.

A backlight module (not shown) is also disposed on the side of the first substrate 11 away from the second substrate 12 for providing a surface light source. The light from the backlight module is incident on the liquid crystal layer 13 from the side of the first substrate 11. The liquid crystal molecule in the liquid crystal layer 13 can be deflected under the action of the electric field to control the transmittance of the light, and therefore to control brightness and darkness of the displayed image.

The display panel also includes a color film layer which can be disposed on the first substrate 11 or the second substrate 12. The color film layer includes red resistor, green resistor, and blue resistor. The color film layer can convert white light into colorful light, thereby achieving color display.

In this embodiment, the plurality of protrusions 121 are disposed on a side surface of the second substrate 12 facing away from the first substrate 11. The cross-sectional shape of the protrusion 121 can be a regular shape such as trapezoid, rectangle, semicircle, semi-oval, etc., or it can also be an irregular shape such as curve, which is not limited in the application. The protrusion 121 may be strip-shaped or block-shaped, but is not limited thereto.

In this embodiment, the optical adjustment layer 14 is made of transparent material. The light transmittance of the optical adjustment layer 14 can be exceed 95%, thereby reducing the impact on brightness of the display panel.

In this embodiment, the optical adjustment layer 14 includes a plurality of grooves 141, where one groove 141 corresponds with one protrusion 121 respectively. The groove 141 is fitted with the protrusion 121. It should be noted that interlock means that the groove 141 and the protrusion 121 are in contact with each other, without an air layer between them.

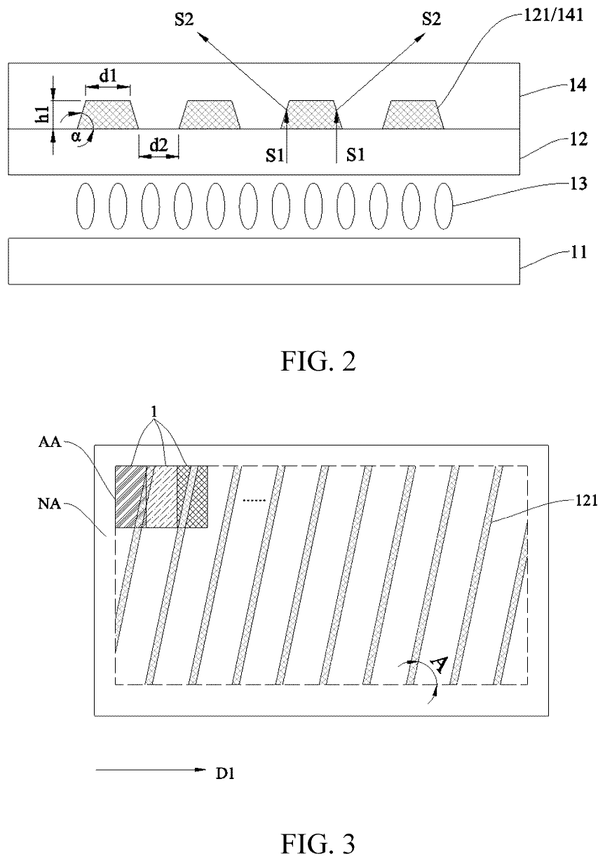

For example, FIG. 2 shows the case where the cross-sectional shape of the protrusion 121 is trapezoidal. The arrangement when the protrusion 121 has other cross-sectional shapes is similar to this. The base angle a of the trapezoid can be from 45 degrees to 90 degrees, the height h1 of the trapezoid can be from 10 microns to 100 microns, the length d1 of the top edge of the trapezoid can be from 5 microns to 100 microns, and the distance d2 between two adjacent trapezoids can be from 0 micron to 50 microns. It should be understood that the size of the trapezoid can be set as needed, and the application does not make limitation to any specific size(s).

In this embodiment, the thickness of the optical adjustment layer 14 is greater than or equal to 20 microns. Meanwhile, in order to ensure a better match between the protrusions 121 and the grooves 141, the thickness of the optical adjustment layer 14 should be greater than the height h1 of the trapezoid.

The optical adjustment layer 14 can be pressure-sensitive glue, where the pressure-sensitive glue is pressure-sensitive and can be adhered to the second substrate 12 under pressure so as to form the groove 141 fitted with the protrusion 121. In order to better fill the surface of the second substrate 12, the values of elastic modulus of the optical adjustment layer 14 are in a range from 45 MPa to 75 MPa. When the optical adjustment layer 14 is pressure-sensitive glue, the optical adjustment layer 14 can on the one hand be used to adjust the emitting angle of the incident light S1, and can on the other hand also be used as an adhesive layer to bond the second substrate 12 with other material layers. Through the above arrangement, the optical adjustment layer 14 can be multiple-used as an adhesive layer, thereby reducing the impact of the optical adjustment layer 14 on the thickness of the display panel.

The optical adjustment layer 14 can also be made of other materials, such as optical glue.

For example, the second substrate 12 is made of glass, and the optical adjustment layer 14 is made of pressure-sensitive glue. The refractive index of glass is in a range from 1.45 to 1.52, and the refractive index of pressure-sensitive glue is about 1.58 (approximately). The material of the second substrate 12 and the optical adjustment layer 14 can also be other transparent materials that meet the requirements for the refractive index. The application does not limit the kind of materials for the second substrate 12 and the optical adjustment layer 14.

It should be noted that in the application, the refractive index refers to the refractive index of the material for light with a wavelength of 550 nanometers.

As is shown in FIG. 2, when the incident light S1 is incident from the second substrate 12 to the optical adjustment layer 14, the incident light S1 will be refracted at the interface between the protrusion 121 and the groove 141. By controlling the angle of the interface between the protrusion 121 and the groove 141, the angle between the emitted light S2 emitted from the optical adjustment layer 14 and the normal line of the plane of the second substrate 12 can be increased, that is, the viewing angle can be increased. Meanwhile, the plane of the second substrate 12 refers to a plane of the second substrate 12, which is parallel to the display surface of the display panel.

In the display panel provided by the application, the protrusions 121 are strip-shaped, and the plurality of protrusions 121 are arranged along the first direction D1, and the plurality of protrusions 121 are spaced apart, where an angle A between the extension direction of the protrusions 121 and the first direction D1 is greater than 0 degrees and less than or equal to 90 degrees.

In this embodiment, as shown in FIG. 3, the protrusion 121 is strip-shaped, which means that the dimension of the protrusion 121 in the extension direction is greater than the dimension of the protrusion 121 in a direction perpendicular to the extension direction. The plurality of protrusions 121 are arranged at intervals, and the plurality of protrusions 121 can be arranged along the first direction D1. By setting the angle A between the extension direction of the protrusion 121 and the first direction D1 to be greater than 0 degrees and less than 90 degrees, the moiré phenomenon caused by optical interference between the protrusion 121 and the sub-pixel 1 of the display panel can be improved. Moiré phenomenon refers to the light and dark stripes formed by optical interference caused by the interaction between the regular-shaped surface structure and the internal components of the display panel. The existence of moiré phenomenon will affect the display effect of the display panel.

Optionally, in some of embodiments, the angle A between the extension direction of the protrusion 121 and the first direction D1 is 90 degrees.

In some embodiments, when the angle A between the extending direction of the protrusion 121 and the first direction D1 is greater than or equal to 45 degrees and less than or equal to 90 degrees, that is, 45°% A≤90°, the viewing angle in the first direction D1 can be increased. When the angle A between the extension direction of the protrusion 121 and the first direction D1 is greater than 0 degrees and less than 45 degrees, that is, 0°<A<45°, the viewing angle in the direction perpendicular to the first direction D1 can be increased.

For example, when the display panel needs to increase the viewing angle in the horizontal direction, the first direction D1 may be the horizontal direction, and 45°SA≤90°. Similarly, when the display panel needs to increase the viewing angle in the vertical direction, the first direction D1 can be the horizontal direction, and 0°<A<45°.

Further, in some embodiments, the angle A between the extension direction of the protrusion 121 and the first direction D1 is greater than or equal to 85 degrees and less than 90 degrees. By the above setting, the moiré phenomenon caused by optical interference between the protrusion 121 and the sub-pixel 1 of the display panel can be improved.

In some embodiments, the cross-sectional shape of each protrusion 121 is the same. That means, each protrusion 121 has the same shape and the same size. By the above setting, the manufacturing process of the protrusion 121 can be simplified.

In some embodiments, the plurality of protrusions 121 include at least two cross-sectional shapes, where the protrusions 121 having different cross-sectional shapes are periodically arranged along the first direction D1. Namely, the cross-sectional shapes of the protrusions 121 may be the same but have different sizes, or the cross-sectional shapes of the protrusions 121 may be different. By the above mentioned setting, the moiré phenomenon caused by optical interference between the protrusion 121 and the sub-pixel 1 of the display panel can be further improved.

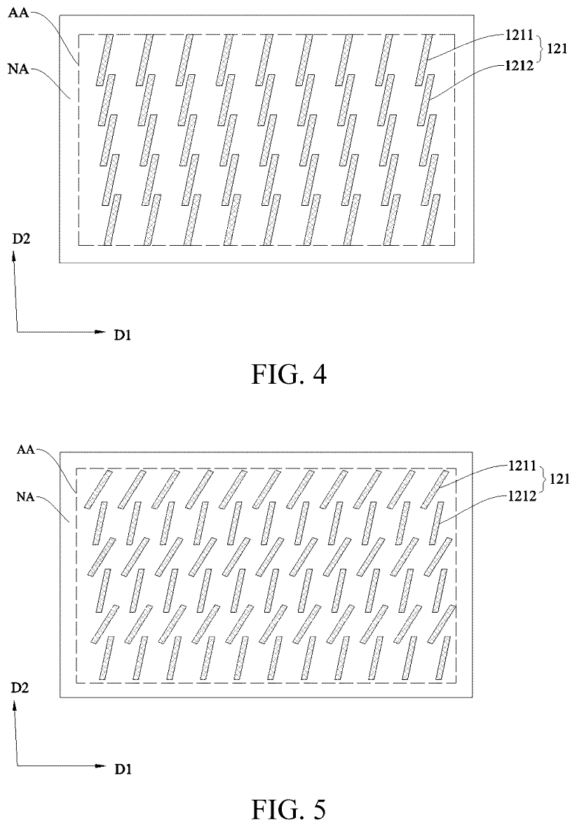

In the display panel provided by the application, as shown in FIGS. 4 and 5, the protrusion 121 at least includes a first sub-section 1211 and a second sub-section 1212 separated from each other. The first sub-section 1211 and the second sub-section 1212 are alternately arranged along a second direction D2. An angle between the first direction D1 and the second direction D2 is greater than 0 degrees and less than or equal to 90 degrees. An extension direction of the first sub-section 1211 is the same as or different from an extension direction of the second sub-section 1212.

In this embodiment, the alternating arrangement of the first sub-section 1211 and the second sub-section 1212 along the second direction D2 means that the lines connecting the center of gravity of the adjacent first sub-section 1211 and the center of gravity of the second sub-section 1212 are parallel to the second direction D2. The frequency, with which the first sub-section 1211 and the second sub-section 1212 are alternately arranged, may be unlimited. For example, one first sub-section 1211 and one second sub-section 1212 are alternately arranged, or one first sub-section 1211 and multiple second sub-sections. 1212 are alternately arranged, or multiple first sub-sections 1211 and one second sub-section 1212 are alternately arranged.

In this embodiment, the cross-sectional shape of the first sub-section 1211 could be the same as or different from the cross-sectional shape of the second sub-section 1212. When the cross-sectional shape of the first sub-section 1211 is different from the cross-sectional shape of the second sub-section 1212, the moire phenomenon caused by optical interference between the protrusion 121 and the sub-pixel 1 of the display panel can be further improved.

In this embodiment, as shown in FIG. 4, the extension direction of the first sub-section 1211 and the extension direction of the second sub-section 1212 may be the same, that is, the extension direction of the first sub-section 1211 is parallel to the extension direction of the second sub-section 1212.

In this embodiment, as shown in FIG. 5, the extension direction of the first sub-section 1211 and the second sub-section 1212 may be different. This arrangement can further reduce the moiré phenomenon caused by interference between the protrusion 121 and the sub-pixel 1 of the display panel.

In the display panel described in the application, the plurality of protrusions 121 can include at least two cross-sectional shapes. The protrusions 121 with different cross-sectional shapes are periodically arranged along the first direction D1.

In this embodiment, when the protrusions 121 include at least two cross-sectional shapes, the protrusions 121 with different cross-sectional shapes are periodically arranged along the first direction D1. For example, when the protrusions 121 include two cross-sectional shapes, the protrusions 121 with the two different cross-sectional shapes can be alternately arranged. It should be understood that the protrusions 121 with the two different cross-sectional shapes can be alternately arranged with various frequencies. For instance, between two adjacent protrusions 121 with the same cross-sectional shape, one or more protrusions 121 with another cross-sectional shape can be placed. The application does not impose any limitation in this regard.

When the number of cross-sectional shapes involved in the protrusion 121 is greater, or when the alternating frequency of protrusions 121 with different cross-sectional shapes is greater, the effect of improving the moiré phenomenon is better, while the processing process thereof is more complicated.

Therefore, the protrusions 121 with different cross-sectional shapes can be periodically arranged along the first direction D1, which can appropriately simplify the processing process, and simultaneously, it can also achieve a better effect of improving the moiré phenomenon.

In the display panel described in the application, as shown in FIG.3 through FIG.5, any of protrusions 121 is spaced apart from the contour lines of the second substrate 12.

In some embodiments, the protrusions 121 could be disposed in the display area (AA) of the display panel, without providing any protrusion 121 in the non-display area (NA).

In some embodiments, the protrusions 121 could be disposed in the display area AA and slightly extend beyond the boundary of the display area AA. That is, the protrusions 121 do not intersect with the contour lines of the second substrate 12.

In this embodiment, according to the aforementioned arrangement, not only the viewing angle of the display panel is increased, but also the issue of decreased mechanical strength at the edge of the second substrate 12 is avoided, which is caused by the structure of the protrusion 121 arranged at the edge of the second substrate 12.

In the display panel mentioned in the application, as shown in FIG. 3, the display panel includes a plurality of sub-pixels 1. The width of one protrusion 121 in the first direction D1 is less than or equal to the width of one sub-pixel 1 in the first direction D1. It should be noted that the sub-pixels 1 and the protrusion 121 in FIG. 3 are merely schematically shown and do not represent the factual size relationship between the sub-pixels 1 and the protrusion 121.

In this embodiment, the width of the protrusion 121 in the first direction D1 is less than or equal to the width of the sub-pixel 1 in the first direction D1. For example, in the first direction D1, one sub-pixel 1 may correspond to at least one protrusion 121. By the above arrangement, the viewing angle of the light emitted by each sub-pixel 1 can be increased.

Optionally, in the first direction D1, each sub-pixel 1 could correspond to at least three protrusions 121. By the above arrangement, the moiré phenomenon can be further improved.

It should be noted that in the application, when the material of the second substrate 12 is glass and the precision of etching the micro-structure on the glass surface is relatively high, the dimensional accuracy of the micro-structure can be in range from 10 microns to 30 microns, thereby enabling one sub-pixel 1 to correspond to a plurality of protrusions 121.

In the display panel provided in the application, as shown in FIG. 1, the display panel includes a first compensation layer 21 and a second compensation layer 22. The first compensation layer 21 is disposed on the side of the first substrate 11 away from the second substrate, and the second compensation layer 22 is disposed on a side of the optical adjustment layer 14 away from the first substrate 11; where a phase difference value (R0) in an in-plane direction of a film of the first compensation layer 21 is greater than or equal to 0 nanometer and less than or equal to 60 nanometers, and a phase difference value (Rth) in a direction perpendicular to the in-plane direction of the film of the first compensation layer 21 is greater than or equal to 100 nanometers and less than or equal to 300 nanometers; while a phase difference value (R0) in an in-plane direction of a film of the second compensation layer 22 is greater than or equal to 0 nanometer and less than or equal to 10 nanometers, and a phase difference value (Rth) in a direction perpendicular to the in-plane direction of the film of the second compensation layer 22 is greater than or equal to 0 nanometer and less than or equal to 15 nanometers.

It should be noted that in the application, the phase difference value (R0) in the in-plane direction of the film is the phase difference value under light with a wavelength of 550 nanometers. Similarly, the phase difference value (Rth) in the direction perpendicular to the in-plane direction of the film is the phase difference value under light with a wavelength of 550 nanometers.

In this embodiment, as shown in FIG. 1, the slow axis directions of the first compensation layer 21 and the second compensation layer 22 are indicated by arrows. By providing the first compensation layer 21 and the second compensation layer 22, light leakage of the display panel at greater viewing angles can be decreased, thereby improving the display effect at greater viewing angles.

The first compensation layer 21 can be bonded to the first substrate 11 by the adhesive layer 15. The adhesive layer 15 could be made of adhesive materials such as pressure-sensitive adhesive, but is not limited thereto.

When the second compensation layer 22 is disposed on the side of the optical adjustment layer 14 away from the first substrate 11, the compensation result is prone to be affected. Therefore, the phase difference value in the in-plane direction of the film of the second compensation layer 22 is greater than or equal to 0 nanometer and less than or equal to 10 nanometers, and the phase difference value in the direction perpendicular to the in-plane direction of the film of the second compensation layer 22 is greater than or equal to 0 nanometer and less than or equal to 15 nanometers. In other words, the second compensation layer 22 meets 0 nm≤R0≤10 nm and 0 nm≤Rth≤15 nm. Through the above mentioned arrangement, the second compensation layer 22 can have no compensation effect. The second compensation layer 22 may be made of materials such as cyclo olefin polymer (COP), triacetyl cellulose (TAC), polymethyl methacrylate (PMMA), etc.

The phase difference value in the in-plane direction of the film of the first compensation layer 21 ranges from 0 nanometer to 60 nanometers, and the phase difference value in the direction perpendicular to the in-plane direction of the film ranges from 100 nanometers to 300 nanometers. In other words, the first compensation layer 21 meets 0 nm≤R0≤60 nm and 100 nm≤Rth≤300 nm, thereby achieving normal compensation effect.

In the display panel provided by the application, as shown in FIG. 1, the display panel further includes a first polarizing layer 31 and a second polarizing layer 32. The first polarizing layer 31 is in contact with the first compensation layer 21 away from the first substrate 11. The second polarizing layer 32 is disposed in contact with the side of the second compensation layer 22 away from the second substrate 12.

In this embodiment, the first polarizing layer 31 and the second polarizing layer 32 are made of Polyvinyl Alcohol (PVA). The direction of the absorption axis of the first polarizing layer 31 and the direction of the absorption axis of the second polarizing layer 32 are perpendicular to each other, as indicated by the arrows in FIG. 1. When the light from the backlight module is incident on the first polarizing layer 31, light with the polarization direction parallel to the absorption axis of the first polarizing layer 31 is absorbed, while light with the polarization direction perpendicular to the absorption axis is transmitted. After passing through the liquid crystal layer 13, the polarization direction of the light is changed, allowing some of the light to pass through the second polarizing layer 32. This arrangement enables control over the transmittance of the display panel.

PVA is highly susceptible to hydrolysis. In order to protect the first polarizing layer 31 and the second polarizing layer 32, protective layers can be added on both sides of these polarizing layers. For example, a first polarizing layer 31 can be provided between the first compensation layer 21 and the first protective layer 41, allowing the first compensation layer 21 to also be multi-used as a protective layer for protecting the first polarizing layer 31. Similarly, the second polarizing layer 32 can be provided between the second compensation layer 22 and a second protective layer 42, allowing the second compensation layer 22 to also be multi-used as a protective layer for protecting the second polarizing layer 32. By multi-using the first compensation layer 21 and the second compensation layer 22 as protective layers, the overall thickness of the display panel can be minimized.

The application also provides a display terminal, which includes the above-mentioned display panel.

In this embodiment, the display terminal could be and of the following: mobile phone, tablet computer, television, monitor, notebook computer, digital photo frame, navigator, or any other products or parts with a display function.

In the above embodiments, each embodiment focuses on various aspects. For parts not described in detail in an embodiment, please refer to the relevant descriptions of other embodiments.

A display panel and a display terminal provided by the embodiments of the present application are described in detail above, where specific examples were used to illustrate the principles and implementation methods of the application. The description of the above mentioned embodiments is solely intended to aid in the understanding of the technical solutions and core ideas of the application. Those skilled in the field should understand that they can still modify the technical solutions described in the preceding embodiments, or make equivalent substitutions for certain technical features, and such modifications or substitutions will not deviate from the scope of the corresponding technical solution in each embodiment of the application.

What is claimed is:

1. A display panel, comprising:
a first substrate;
a second substrate spaced apart from and opposite to the first substrate, wherein a plurality of protrusions are disposed on a side surface of the second substrate away from the first substrate;
a liquid crystal layer disposed between the first substrate and the second substrate; and
an optical adjustment layer disposed on a side of the second substrate away from the first substrate, wherein a plurality of grooves are disposed on the optical adjustment layer and each of the grooves is fitted with a corresponding one of the protrusions;
wherein a refractive index of the second substrate is less than a refractive index of the optical adjustment layer.

2. The display panel according to claim 1, wherein each of the protrusions is in a strip shape, the plurality of protrusions are arranged along a first direction, and the plurality of protrusions are spaced apart; and
wherein an angle between an extension direction of the protrusions and the first direction is greater than 0 degrees and less than or equal to 90 degrees.

3. The display panel according to claim 2, wherein the angle between the extension direction of the protrusions and the first direction is greater than or equal to 85 degrees and less than 90 degrees.

4. The display panel according to claim 2, wherein each of the protrusions at least comprises a first sub-section and a second sub-section separated from each other, the first sub-section and the second sub-section are alternately arranged along a second direction, an angle between the first direction and the second direction is greater than 0 degrees and less than or equal to 90 degrees, and an extension direction of the first sub-section is same as or different from an extension direction of the second sub-section.

5. The display panel according to claim 2, wherein a cross-sectional shape of each of the protrusions is the same; or
the plurality of protrusions comprise at least two cross-sectional shapes, and the plurality of protrusions with different ones of the at least two cross-sectional shapes are periodically arranged along the first direction.

6. The display panel according to claim 1, wherein any one of the protrusions is spaced apart from contour lines of the second substrate.

7. The display panel according to claim 2, wherein the display panel comprises a plurality of sub-pixels, and a width of one of the protrusions in the first direction is less than or equal to a width of one of the sub-pixels in the first direction.

8. The display panel according to claim 1, wherein the display panel comprises a first compensation layer and a second compensation layer, the first compensation layer is disposed on a side of the first substrate away from the second substrate; and the second compensation layer is disposed on a side of the optical adjustment layer away from the first substrate;
wherein a phase difference value in an in-plane direction of a film of the first compensation layer is greater than or equal to 0 nanometer and less than or equal to 60 nanometers, and a phase difference value in a direction perpendicular to the in-plane direction of the film of the first compensation layer is greater than or equal to 100 nanometers and less than or equal to 300 nanometers; and
wherein a phase difference value in an in-plane direction of a film of the second compensation layer is greater than or equal to 0 nanometer and less than or equal to 10 nanometers, and a phase difference value in a direction perpendicular to the in-plane direction of the film of the second compensation layer is greater than or equal to 0 nanometer and less than or equal to 15 nanometers.

9. The display panel according to claim 8, wherein the display panel further comprises a first polarizing layer and a second polarizing layer, the first polarizing layer is disposed in contact with a side of the first compensation layer away from the first substrate, and the second polarizing layer is disposed in contact with a side of the second compensation layer away from the second substrate.

10. The display panel according to claim 3, wherein a cross-sectional shape of each of the protrusions is the same; or
the plurality of protrusions comprise at least two cross-sectional shapes, and the plurality of protrusions with different ones of the at least two cross-sectional shapes are periodically arranged along the first direction.

11. The display panel according to claim 4, wherein a cross-sectional shape of each of the protrusions is the same; or
the plurality of protrusions comprise at least two cross-sectional shapes, and the plurality of protrusions with different ones of the at least two cross-sectional shapes are periodically arranged along the first direction.

12. The display panel according to claim 2, wherein the display panel comprises:
a display area and a non-display area;
wherein the plurality of protrusions are disposed within the display area of the display panel.

13. The display panel according to claim 6, wherein the protrusions do not intersect with contour lines of the second substrate.

14. The display panel according to claim 8, wherein the first compensation layer is bonded to the first substrate by an adhesive layer.

15. The display panel according to claim 9, wherein protective layers are added on two sides of each of the first polarizing layer and the second polarizing layer.

16. The display panel according to claim 1, wherein a cross-sectional shape of each of the protrusions is a trapezoid; and
wherein a thickness of the optical adjustment layer is greater than a height of the trapezoid.

17. A display terminal, comprising a display panel;
wherein the display panel comprises:
a first substrate;
a second substrate spaced apart from and opposite to the first substrate, wherein a plurality of protrusions is disposed on a side surface of the second substrate away from the first substrate;
a liquid crystal layer disposed between the first substrate and the second substrate; and
an optical adjustment layer disposed on a side of the second substrate away from the first substrate, wherein the optical adjustment layer is provided with a plurality of grooves, and each of the grooves is fitted with a corresponding one of the protrusions;
wherein a refractive index of the second substrate is less than a refractive index of the optical adjustment layer.

18. The display terminal according to claim 17, wherein each of the protrusions is in a strip shape, the plurality of protrusions are arranged along a first direction, and the plurality of protrusions are spaced apart; and
wherein an angle between an extension direction of the protrusions and the first direction is greater than 0 degrees and less than or equal to 90 degrees.

19. The display terminal according to claim 18, wherein the angle between the extension direction of the protrusions and the first direction is greater than or equal to 85 degrees and less than 90 degrees.

20. The display terminal according to claim 18, wherein each of the protrusions at least comprises a first sub-section and a second sub-section separated from each other, the first sub-section and the second sub-section are alternately arranged along a second direction, an angle between the first direction and the second direction is greater than 0 degrees and less than or equal to 90 degrees, and an extension direction of the first sub-section is same as or different from an extension direction of the second sub-section.
